(19) United States
(12) Patent Application Publication
(10) Pub. No.: US 2022/0012110 A1
(43) Pub. Date: Jan. 13, 2022

(54) NETWORKING-RELATED SYSTEM CALL INTERCEPTION AND MODIFICATION

(71) Applicant: NETFLIX, INC., Los Gatos, CA (US)

(72) Inventors: Sargun DHILLON, San Francisco, CA (US); Keerti LAKSHMINARAYAN, San Jose, CA (US)

(21) Appl. No.: 17/372,341

(22) Filed: Jul. 9, 2021

Related U.S. Application Data
(60) Provisional application No. 63/049,782, filed on Jul. 9, 2020.

(51) Int. Cl. G06F 9/54

(52) U.S. Cl. CPC G06F 9/547; G06F 9/546

(57) ABSTRACT

Various embodiments of the present application set forth a computer-implemented method that includes intercepting a first system call from a client application, wherein the first system call comprises a first request to connect to a first destination using a first set of system call parameters; determining, based on the first destination, a second set of system call parameters; generating a second system call, wherein the second system call comprises a second request to connect to a target destination using the second set of system call parameters; and causing a connection to be established from the client application to the target destination based on the second system call.

### CROSS-REFERENCE TO RELATED APPLICATIONS

This application claims the priority benefit of the U.S. Provisional Patent Application titled, “IPV6 TRANSITION MECHANISM,” filed on Jul. 9, 2020 and having Ser. No. 63/049,782. The subject matter of this related application is hereby incorporated herein by reference.

### BACKGROUND

### Field of the Various Embodiments

The various embodiments relate generally to computer science and, more specifically, to intercepting and modifying networking-related system calls.

### Description of the Related Art

A computing system executes various applications, such as web browsers, media players, file management applications, server software, and the like, that communicate with various destinations outside of the computing system. To communicate with a destination, a given application establishes a direct connection to the destination and manages its connection to the destination. However, in some cases, rather than directly connecting to a destination, the connection from an application to the destination needs to be routed or otherwise modified.

One approach to modifying the destination of messages transmitted by an application is to use network address translation to modify the network address information included in a packet during transit. Network address translation provides a mapping between different IP addresses, e.g., from an intended destination to an alternate destination. However, one drawback of this approach is that the modification occurs on a packet-by-packet basis. Each packet transmitted from an application needs to be monitored and, if necessary, modified. Therefore, using network address translation introduces significant processing overheads and packet transmission delays.

Another approach to modifying the destination of messages transmitted by an application is to use a proxy to monitor communications between the application and various destinations. The proxy application can intercept and redirect requests to different destinations. However, similar to network address translation, one drawback of this approach is that the modification occurs on a request-by-request basis. Each message transmitted from an application needs to be monitored and, if necessary, redirected. Therefore, using a proxy also introduces significant processing overheads and packet transmission delays.

As the foregoing illustrates, what is needed in the art are more effective techniques for modifying client connections to external destinations.

### SUMMARY

Various embodiments of the present application set forth a computer-implemented method that includes intercepting a first system call from a client application, wherein the first system call comprises a first request to connect to a first destination using a first set of system call parameters; determining, based on the first destination, a second set of system call parameters; generating a second system call, wherein the second system call comprises a second request to connect to a target destination using the second set of system call parameters; and causing a connection to be established from the client application to the target destination based on the second system call.

At least one technological advantage of the disclosed techniques relative to the prior art is that, with the disclosed techniques, a connection from a client application to an external destination is modified more efficiently compared to prior art techniques. In particular, a connection system call made by a client application is modified by a manager application, and a connection from the client application to a different destination is established using the modified connection system call. Accordingly, using the disclosed techniques, packets and/or messages from the client application do not have to be monitored and re-routed to the different destination, which results in less processing overhead and lower packet transmission latency relative to conventional techniques. These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 is a conceptual illustration of a computing device configured to implement one or more aspects of the present disclosure;

FIGS. 2A and 2B illustrate modified connections between the client of FIG. 1 and one or more target destinations, according to various embodiments;

FIG. 3 illustrates an example call flow diagram showing interactions between various components of the computing device of FIG. 1, according to various embodiments;

FIG. 4 illustrates an example flow diagram of method steps for modifying a connection request, according to various embodiments;

FIG. 5 illustrates an example flow diagram of method steps for modifying a connection request, according to various other embodiments;

FIG. 6 illustrates an example flow diagram of method steps for modifying a connection request, according to various other embodiments;

FIG. 7 illustrates an example flow diagram of method steps for modifying a connection request, according to various other embodiments;

FIG. 8 illustrates a network infrastructure, according to various embodiments;

FIG. 9 is a more detailed illustration of the content server of FIG. 1, according to various embodiments;

FIG. 10 is a more detailed illustration of the control server of FIG. 1, according to various embodiments; and

FIG. 11 is a more detailed illustration of the endpoint device of FIG. 1, according to various embodiments.

### DETAILED DESCRIPTION

In the following description, numerous specific details are set forth to provide a more thorough understanding of the various embodiments. However, it will be apparent to one of skilled in the art that the inventive concepts may be practiced without one or more of these specific details.

### Overview

To communicate with a destination, a given application typically establishes a direct connection to the destination and manages its connection to the destination. However, in some cases, rather than directly connecting to a destination, the connection from an application to the destination needs to be routed or otherwise modified.

As an example, in order to utilize networking functionality not implemented in the application or receive enhance connection management services, the application may instead connect to a service mesh. A service mesh is a software component that executes on the computing system that provides and manages networking functionality, features, and services on behalf of the connected application. A given application connects to the service mesh, and the service mesh then connects to the intended destination of the given application.

As another example, in order to connect to and communicate with the various destinations, a given application is assigned an external IP address. IP addresses utilize two different protocols, IPv4 and IPv6. Because IPv6 addresses are more numerous than IPv4 addresses, an application may be assigned an IPv6 address. However, an application using an IPv6 address cannot establish a connection to a destination that is using an IPv4 address. Therefore, messages from the application to a destination using an IPv4 address may be re-routed to a different destination.

Prior art techniques handle re-routing or re-directing messages by monitoring communications between the application and the destination, identifying messages that should be re-routed, and re-routing the messages accordingly. However, the monitoring and re-routing must be performed continuously and on every message that is transmitted by the application. Thus, prior art approaches introduce significant processing overhead and message transmission delays. Additionally, if the monitoring and re-routing mechanism fails, then message transmission via established communications will also fail.

In contrast, the disclosed techniques enable a manager to re-route messages more efficiently by intercepting and modifying a connection system call. The modified connection system call establishes a connection from an application to a different destination or using a different route. Messages from the application via the connection are automatically re-routed without having to monitor or modify each message. Accordingly, using the disclosed techniques results in less processing overhead and lower packet transmission latency relative to conventional techniques.

### System Call Interception and Modification

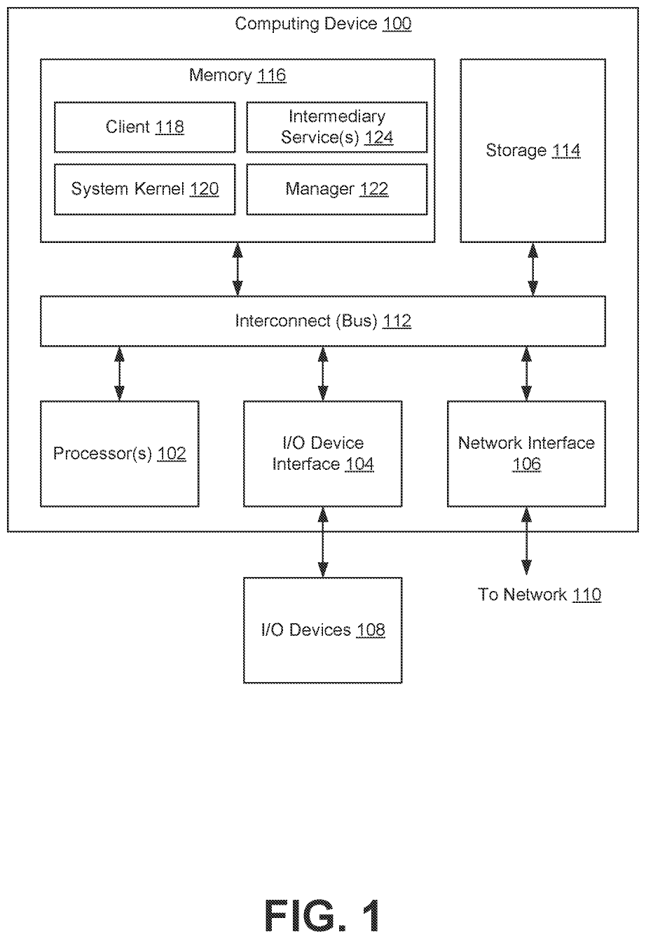

FIG. 1 is a conceptual illustration of a computing device 100 configured to implement one or more aspects of the present disclosure. As shown, computing device 100 includes an interconnect (bus) 112 that connects one or more processing units 102, an input/output (I/O) device interface 104 coupled to one or more input/output (I/O) devices 108, memory 116, a storage 114, and a network interface 106 connected to a network 110.

Computing device 100 includes a server computer, a desktop computer, a laptop computer, a smart phone, a personal digital assistant (PDA), tablet computer, or any other type of computing device configured to receive input, process data, and optionally display images, and is suitable for practicing one or more embodiments. Computing device 100 described herein is illustrative and that any other technically feasible configurations fall within the scope of the present disclosure.

Processing unit(s) 102 includes any suitable processor implemented as a central processing unit (CPU), a graphics processing unit (GPU), an application-specific integrated circuit (ASIC), a field programmable gate array (FPGA), an artificial intelligence (Al) accelerator such as a tensor processing unit (TPU), any other type of processing unit, or a combination of different processing units, such as a CPU configured to operate in conjunction with a GPU. In general, processing unit(s) 102 may be any technically feasible hardware unit capable of processing data and/or executing software applications. Further, in the context of this disclosure, the computing elements shown in computing device 100 may correspond to a physical computing system (e.g., a system in a data center) or may be a virtual computing embodiment executing within a computing cloud.

In one embodiment, I/O devices 108 include devices capable of providing input, such as a keyboard, a mouse, a touch-sensitive screen, and so forth, as well as devices capable of providing output, such as a display device. Additionally, I/O devices 108 may include devices capable of both receiving input and providing output, such as a touchscreen, a universal serial bus (USB) port, and so forth. I/O devices 108 may be configured to receive various types of input from an end-user (e.g., a designer) of computing device 100, and to also provide various types of output to the end-user of computing device 100, such as displayed digital images or digital videos or text. In some embodiments, one or more of I/O devices 108 are configured to couple computing device 100 to a network 110.

Network 110 includes any technically feasible type of communications network that allows data to be exchanged between computing device 100 and external entities or devices, such as a web server or another networked computing device. For example, network 110 may include a wide area network (WAN), a local area network (LAN), a wireless (WiFi) network, and/or the Internet, among others.

Storage 114 includes non-volatile storage for applications and data, and may include fixed or removable disk drives, flash memory devices, and CD-ROM, DVD-ROM, Blu-Ray, HD-DVD, or other magnetic, optical, or solid-state storage devices. Client 118, system kernel 120, manager 122, and one or more intermediary services 124 may be stored in storage 114 and loaded into memory 116 when executed.

Memory 116 includes a random-access memory (RAM) module, a flash memory unit, or any other type of memory unit or combination thereof. Processing unit(s) 102, I/O device interface 104, and network interface 106 are configured to read data from and write data to memory 116. Memory 116 includes various software programs and other program instructions that can be executed by processing unit(s) 102 and application data associated with said software programs, including client 118, system kernel 120, manager 122, and one or more intermediary services 124.

Client 118 can be any software program or application that executes on computing device 110. In some embodiments, client 118 is configured to issue various network-related system calls, such as socket requests to obtain sockets for communicating with various destinations and connection requests to establish connections to the destinations using the obtained sockets.

The one or more intermediary services 124 include various software programs and/or other program instructions, external to client 118, that provide functionality for interacting with client 118 and/or destinations to which client 118 communicate. In some embodiments, the one or more intermediary services 124 include a service mesh. The service mesh is configured to facilitate communications between applications, such as client 118, and various destinations. For example, the service mesh could perform services such as network routing, throughput monitoring, load-balancing, authenticity verification, confidentiality, and so forth.

In some embodiments, resources on computing device 100 are partitioned into a plurality of namespaces. Client 118 executes in a namespace that is assigned an IPv6 address. Client 118 can only connect to and receive connections from destinations with an IPv6 address, and cannot connect to or receive connections from destinations with an IPv4 address. The one or more intermediary services 124 include an IPv4 transition namespace that is assigned an IPv4 address. Applications executing in the IPv4 transition namespace can connect to and receive connections from destinations with an IPv4 address. As discussed in further detail below, the IPv4 transition namespace can be used to establish egress connections from applications executing in an IPv6 namespace to destinations with an IPv4 address.

System kernel 120 is an operating system kernel of computing device 100. System kernel 120 performs system functions such as managing hardware devices including storage 114, I/O device interface 104, and network interface 106. System kernel 120 also provides process and memory management models for client 118, intermediary service 124, and manager 122. In some embodiments, system kernel 120 receives system calls requesting kernel level services from the operating system of computing device 100, such as requests to create communication endpoints (e.g., sockets) and requests to connect communication endpoints to specified destinations, from applications executing on computing device 100, such as client 118. System kernel 120 performs, or attempts to perform, the function requested in the system call. Additionally, system kernel 120 could notify the requesting application whether the requested function was performed successfully. For example, system kernel 120 could receive a request from client 118 to establish a connection to a target destination. System kernel 120 establishes the connection and sends a notification to client 118 indicating that the connection was successfully established.

In some embodiments, system kernel 120 monitors system calls made by applications executing on computing device 100, such as client 118. System kernel 120 determines whether to intercept the system call and if so, intercepts the system call. System kernel 120 provides the system call to another application, such as manager 122 and/or notifies the other application of the system call. In some embodiments, system kernel 120 determines whether to intercept a system call based on whether the type of system call is included in a set of one or more specific system calls. For example, system kernel 120 could be configured to intercept one or more of: socket, connect, sendto, recvfrom, sendmsg, recvmsg, bind, accept, listen, accept4, getsockname, and/or getpeername. In some embodiments, system kernel 120 determines which system calls to intercept by using system call filtering to filter incoming system calls. For example, system kernel 120 could use a seccomp BPF (secure computing with Berkley Packet Filter) program to filter and intercept the one or more specified system calls. The seccomp BPF program could include rules that specify which system calls should be intercepted.

In some embodiments, manager 122 receives an intercepted system call and modifies the intercepted system call. Modifying the intercepted system call can include, for example, modifying the values of one or more parameters of the system call, replacing or modifying one or more objects specified in the system call, replacing or modifying the output of the system call, replacing or modifying the return value of the system call, and the like. Although examples are described below with reference to connection system calls, any type of system call can be intercepted and/or modified. The modifications to an intercepted system call may vary depending on the particular intercepted system call. For example, a system call for obtaining the address of a peer connected to a specified socket could be modified to return a virtual IP address corresponding to a real IP address that the socket is connected to, rather than the real IP address.

In some embodiments, the intercepted system call comprises a connection request. The connection request specifies a target destination and a socket for connecting to the target destination. In some embodiments, manager 122 generates a modified connection request that specifies a different destination. Messages sent by client 118 to the target destination using the socket connection would instead be transmitted to the different destination. For example, the target destination could be a destination that is external to computing device 100. Manager 122 replaces the external destination specified in the connection request with an internal destination, such as a service mesh or other intermediary service 124. After the modified connection request is established, messages transmitted by client 118 to the external destination are routed to the internal destination. Alternately, manager 122 could replace the external destination with a different external destination. For example, a plurality of external destinations could be associated with the same service or functionality, such as providing the same content. Manager 122 could select a different external destination from the plurality of external destinations to provide load-balancing between the plurality of external destinations.

In some embodiments, manager 122 accesses one or more rules, policies, and other routing information that indicate whether and how to modify various connection requests. The routing information could specify, for example, alternate addresses associated with different destination addresses, applications whose functionality should be managed by a service mesh, destination addresses whose communications should be managed by a service mesh, available routes to different destination addresses, and the like. The one or more rules, policies, and other routing information could be obtained from any number or type of different data sources. In some embodiments, the one or more rules, policies, and other routing information are stored by computing device 100, for example, in storage 114 and retrieved by manager 122 when evaluating an intercepted connection request. In some embodiments, to evaluate one or more rules and/or policies, manager 122 requests and/or retrieves routing information related to the one or more rules and/or policies. For example, manager 122 could determine, based on current routing information, whether a target destination address is reachable. Manager 122 could select an alternate destination address if the target destination address is not currently reachable or available.

In some embodiments, manager 122 creates a different socket for connecting to the target destination or the different destination. The different socket may be a different connection type and/or created in a different namespace. Manager 122 generates a modified connection request that specifies the different socket. In some embodiments, the socket specified in the connection request is a socket that is used to connect to external destinations and/or that cannot be used for internal or local destinations. Manager 122 creates a new socket that is used to connect to local destinations and/or that cannot be used for external destinations. The new socket may be more efficient than the original socket when used to connect to local destinations. For example, the socket specified in the connection request could be a sock stream socket generated using a socket( ) system call. Manager 122 determines that the target destination or the different destination is a local destination, and creates a second socket using a socketpair( ) system call. Manager 122 generates a modified connection request that specifies the second socket. As another example, client 118 could execute in a first namespace. When client 118 creates a socket, the socket is created in the first namespace. Manager 122 could determine, based on the target destination or the different destination, that a second namespace should be used. Manager 112 switches to or executes in a second namespace, for example through intermediary service 124, and create a second socket in the second namespace. Manager 122 generates a modified connection request that specifies the second socket.

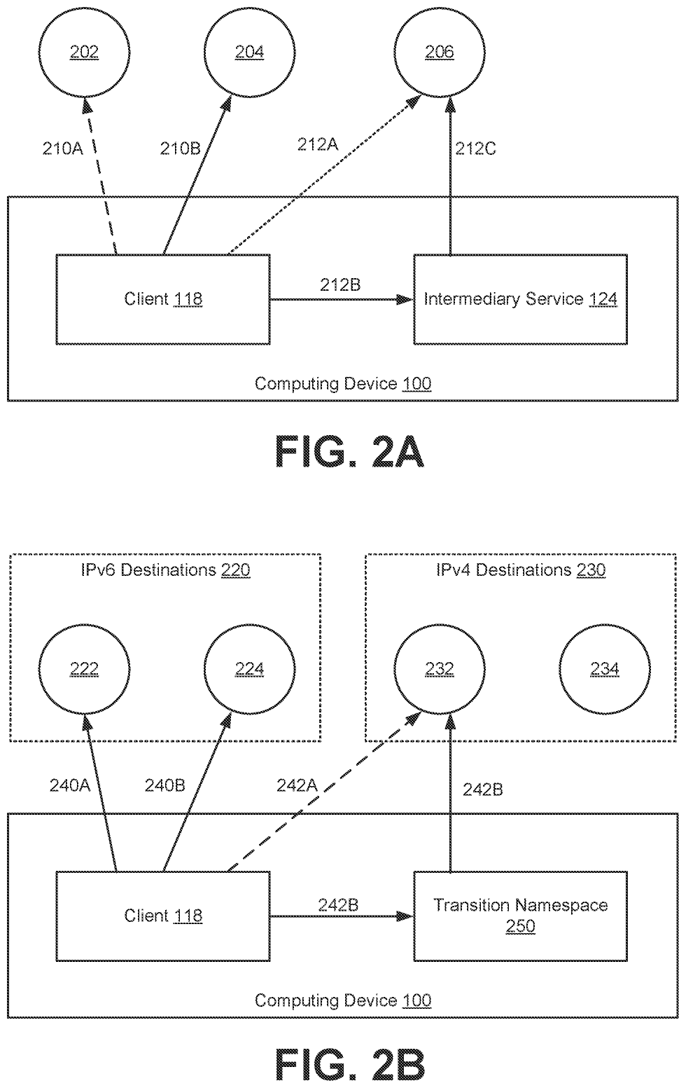

FIG. 2A illustrates example modified connections between client 118 and target destinations, according to various embodiments. As shown in FIG. 2A, client 118 can request connections to a plurality of destinations, e.g., destination 202, destination 204, and destination 206. In some embodiments, when client 118 requests a connection to a destination, manager 122 modifies the connection request to establish a connection to a different destination.

As an example, client 118 sends a connection request to establish connection 210A to destination 202. Manager 122 determines that client 118 should instead connect to destination 204. Manager 122 modifies the connection request to establish connection 210B from client 118 to destination 204. Messages transmitted by client 118 are transmitted via connection 210B to destination 204.

As another example, client 118 sends a connection request to establish connection 212A to destination 206. Manager 122 determines that client 118 should communicate with destination 206 via an intermediary service 124, such as a service mesh. Manager 122 modifies the connection request to establish connection 212B from client 118 to intermediary service 124. Intermediary service 124 then establishes connection 212C to destination 206. Messages transmitted by client 118 are transmitted via connection 212B to intermediary service 124. Intermediary service 124 can perform various processing operations on the messages and/or forward the messages to destination 206 via connection 212C.

FIG. 2B illustrates an example of modified connections between client 118 and target destinations, according to various embodiments. As shown in FIG. 2B, IPv6 destinations 220 include destination 222 and destination 224, and IPv4 destinations 230 include destination 232 and destination 234. If client 118 executes in an IPv6 namespace, then client 118 can communicate with the IPv6 destinations 220. For example, client 118 communicates with destination 222 via connection 240A and with destination 224 via connection 240B. However, IPv6 addresses are not backwards compatible, so client 118 cannot communicate directly with IPv4 destinations 230. In some embodiments, when client 118 requests a connection to an IPv4 destination 230, manager 122 modifies the connection request to establish a connection in an IPv4 transition namespace 250. For example, client 118 sends a connection request to establish connection 242A to destination 232. Manager 122 determines that destination 232 is an IPv4 destination. Manager 122 modifies the connection request to establish connection 242B using transition namespace 250.

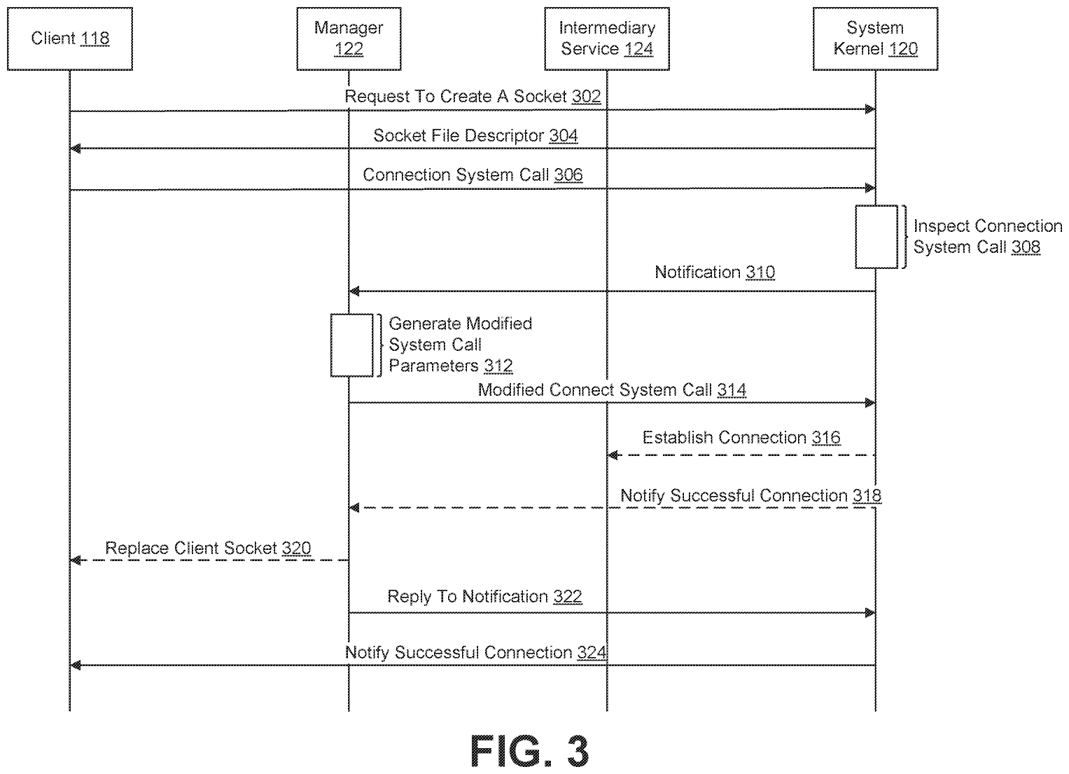

FIG. 3 illustrates an example call flow diagram showing interactions between various components of computing device 100, according to various embodiments of the present invention. One or more components of the computing device 100 may perform various operations for intercepting and modifying system calls made by a client application, such as connect and socket system calls. Although the interactions between the various components are shown in an order, persons skilled in the art will understand that the interactions may be performed in a different order, interactions may be repeated or skipped, and/or may be performed by components other than those illustrated in FIG. 3.

Client 118 sends a request to create a socket 302 to system kernel 120. The socket request 302 can include one or more parameters associated with the socket, such as a socket type, a communication domain, and a communication protocol. For example, client 118 sends a socket( ) call to system kernel 120.

In response to receiving the socket request 302, system kernel 120 creates a socket for communications by client 118. The socket is associated with a file descriptor 304. The file descriptor 304 is a unique identifier that is used to identify the socket when specifying input parameters for a system call. System kernel 120 provides the socket file descriptor 304 to client 118.

Client 118 uses the socket file descriptor 304 when generating a request to establish a connection to a target destination. Client 118 generates and sends a connection system call 306. The connection system call 306 can include parameters associated with the requested connection, such as a socket for the connection and a target destination. The socket for the connection is identified using the socket file descriptor 304. For example, client 118 sends a connect(fd, addr) call to system kernel 120, where fd represents the socket file descriptor 304 and addr represents an address of the target destination.

System kernel 120 receives the connection system call 306 and performs one or more operations 308 to inspect the connection system call and determine whether to handle the connection system call normally or to intercept the connection system call. In some embodiments, the inspection is performed by a software program that is configured to filter the system calls that should be intercepted. In some embodiments, determining whether to intercept the connection system call is based on one or more of the type of system call, the client that generated the system call, and/or a target destination specified in the system call.

System kernel 120 determines that the connection system call 306 should be intercepted, and sends a notification to manager 122. In some embodiments, the notification indicates one or more of the client that generated the system call (e.g., client 118), the type of system call (e.g., connect( ) call), and/or the one or more parameters included in the system call (e.g., the file descriptor and the target destination). Manager 122 is configured to intercept and/or modify intercepted system calls. In response to receiving the notification, manager 122 performs one or more operations 312 to generate modified system call parameters based on the system call 306.

In some embodiments, generating the one or more modified system call parameters includes sending a request to create a socket to system kernel 120 and receiving, from system kernel 120, a file descriptor for a new socket. The one or more modified system call parameters include the file descriptor for the new socket. For example, if a target destination or a modified target destination is a local destination, then manager 122 can use a socketpair( ) call to create a local socket pair, and replace the socket generated by a socket( ) call with one of the sockets in the socket pair. As another example, rather than obtaining the socket created by client 118, manager 122 can use a socket( ) call to create a new socket for establishing a connection to a new target address.

In some embodiments, client 118 executes in a namespace that is assigned an IPv6 address. If the address of the target destination is an IPv4 address, then manager 122 creates a new socket in an IPv4 namespace. For example, manager 122 executes in or switches execution to an IPv4 transition namespace and sends a request to create a new socket to system kernel 120 while in the IPv4 transition namespace. In some embodiments, manager 122 switches to an IPv4 transition namespace by sending a setns(fd, CLONE_NEWNET) call to system kernel 120, where fd represents a file descriptor associated with a target namespace (e.g., the IPv4 transition namespace), and CLONE_NEWNET indicates that the target namespace is a network namespace.

In some embodiments, generating the one or more modified system call parameters includes obtaining the socket file descriptor 304 from the client 118 and receiving the socket file descriptor 304 for the socket established by the prior socket request 302 from the client. In some embodiments, to obtain socket file descriptor 304, manager 122 calls pidfd_getfd(pidfd, targetfd), where targetfd represents a file descriptor associated with a target file descriptor (i.e., socket file descriptor 304), and pidfd represents a file descriptor associated with a process (i.e., client 118) that opened the target file descriptor. pidfd_getfd( ) is a system call for extracting a copy of a target file descriptor from another process. When the pidfd_getfd( ) call is executed, the local file descriptor identifier associated with the target filed descriptor is returned. The local file descriptor identifier can be used to issue further system calls that operate on the target file descriptor, e.g., the client socket. The client socket can be used in a modified system call by the manager 122 and/or replaced with a new socket created by manager 122. In some embodiments, the manager 122 obtains socket options associated with the client socket and applies the socket options to the new socket.

In some embodiments, determining the one or more modified system call parameters includes determining a new target destination address for the connection system call 306. For example, the connection system call 306 from client 118 could specify an address corresponding to an external destination, and manager 122 determines a new target destination address that is for a service mesh or other intermediary service 124 that is internal to computing device 100. As another example, the specified address could be a virtual IP address, and manager 122 determines an actual IP address corresponding to the virtual IP address. As a third example, the specified address could be included in a plurality of addresses that correspond to the same service. Manager 122 determines that a different address included in the plurality of address should be used instead of the specified address, for example, for load balancing or if the specified address is unavailable. The one or more modified system calls include the new target destination address.

The manager 122 sends a modified connection system call 314 to the system kernel 120 that specifies the one or more modified system call parameters. The system kernel 120 establishes a connection based on the modified system call parameters, and sends a notification 318 to manager 122 notifying the manager 122 of the successful connection. In some embodiments, the modified connection system call 314 specifies a file descriptor of a socket for establishing the connection. The specified file descriptor could be file descriptor 304 that manager 122 obtained from client 118 or a file descriptor associated with a new socket created by manager 122. System kernel 120 establishes the connection using the specified file descriptor.

In some embodiments, if the modified connection system call 314 specified an internal destination, such as a service mesh, then system kernel 120 establishes a connection 316 to the internal destination. If the modified connection system call 314 specified a different external destination, then system kernel 120 establishes a connection (not shown) to the different external destination. In some embodiments, the service mesh establishes a connection (not shown) to the original destination specified in connection system call 306. For example, the manager 122 could send the original destination to the service mesh, and the service mesh establishes a connection to the original destination. As another example, if the manager 122 established a connection for the client using a new socket, the manager 122 could establish a connection to the original destination using the original socket created by the socket request 302 from the client, e.g., using file descriptor 304, and provide the original socket to the service mesh.

In some embodiments, if the manager 122 established the connection using a new socket, the manager 122 performs one or more operations 320 to replace the client socket 302 with the new socket. In some embodiments, manager 122 calls addfd( )with parameters indicating a first file descriptor for the new socket and, optionally, a second file descriptor for the client socket. addfd( ) is a function for adding and/or replacing file descriptors. In some embodiments, addfd( ) is an input/output control (ioctl) call that manager 122 can call via the seccomp BPF program. addfd( ) receives, as parameters, at least a first file descriptor corresponding to the replacement file and, optionally, a second file descriptor corresponding to the file to be replaced in the destination process, i.e., the client application. If addfd( ) is called with the first file descriptor and the second file descriptor, when the addfd( ) call is executed, the file corresponding to the second file descriptor (i.e., the client socket) is replaced by the file corresponding to the first file descriptor (i.e., the new socket). Additionally, the file corresponding to the client socket can be closed after the replacement is completed. If addfd( ) is called with only the first file descriptor, the file corresponding first file descriptor (i.e., the new socket) is added to the destination process (i.e., the client application). Manager 122 sends the addfd( ) call to the system kernel 120 and system kernel 120 performs the above operations to replace the first file descriptor with the second file descriptor.

After manager 122, receives notification 318 indicating that the connection was successfully established, manager 122 sends a reply 322 to system kernel 120. The reply 322 is a response to the notification 310 from system kernel 120. In some embodiments, the reply 322 indicates that the manager 122 has successfully set up a connection on behalf of the client 118.

The system kernel 120 sends a notification 324 to the client 118, notifying client 118 that a connection was successfully established in response to the connection system call 306. In some embodiments, the modifications to the socket and/or to the target destination are transparent to the client 118. The client 118 treats the connection as if it were the connection the client had originally requested, i.e., sends and receives data using the socket at socket file descriptor 304. The client 118 is not aware or affected by the changes to the underlying socket at socket file descriptor 304.

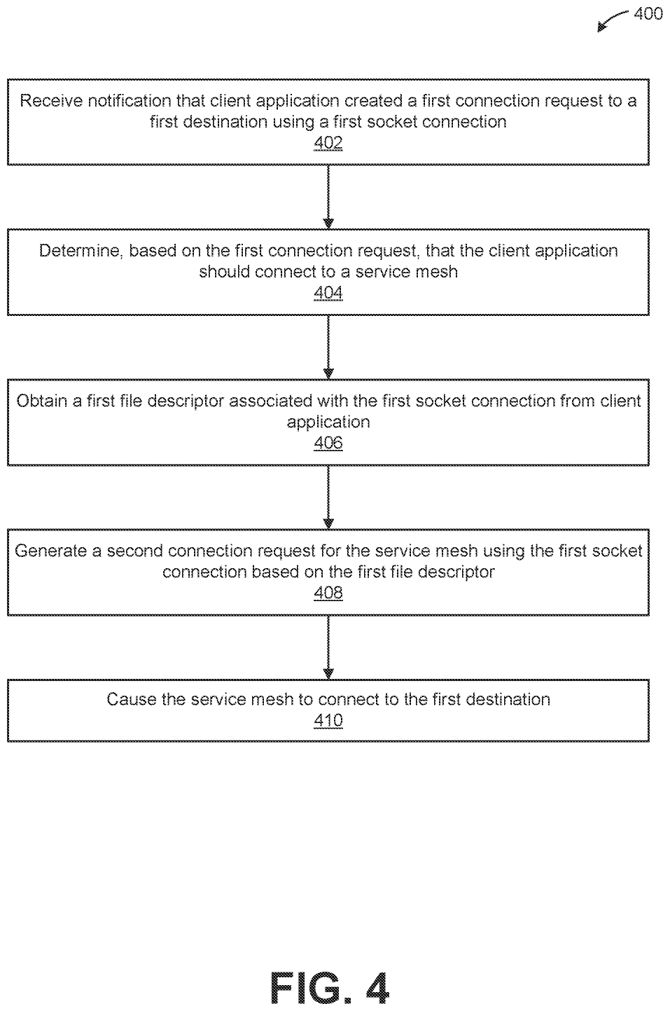

FIG. 4 sets forth a flow diagram of method steps 400 for intercepting and modifying a connection request, according to various embodiments of the present invention. Although the method steps are described with reference to the system of FIG. 1 and call flows of FIG. 3, persons skilled in the art will understand that any system configured to implement the method steps, in any order, falls within the scope of the present invention.

As shown in FIG. 4, method 400 begins at step 402, where manager 122 receives a notification that a client application created a first connection request to a first destination using a first socket connection. For example, manager 122 receives a notification 310 from system kernel 120 that client 118 called a system call 306. In some embodiments, notification 310 includes information identifying one or more of the client 118, the system call 306, or one or more parameters of system call 306. As an example, client 118 calls connect(5, 1.2.3.4), where 5 is the file descriptor for the first socket connection and 1.2.3.4 is address of the first destination. Notification 310 could include indicate that the system call was a connect( ) call, that 5 is the identifier used by client 118 for the file descriptor, and/or that the target destination is the IP address 1.2.3.4.

At step 404, manager 122 determines, based on the first connection request, that the client application should connect to a service mesh. For example, manager 122 determines that client 118 should connect to a service mesh included in intermediary services 124 for communicating with the first destination. In some embodiments, manager 122 determines whether client 118 should connect to a service mesh based on the identity of client 118. For example, manager 122 could be configured to modify connection requests from client 118 to use a service mesh. In some embodiments, manager 122 determines whether client 118 should connect to a service mesh based on the first destination. For example, manager 122 could be configured to modify connection requests to the first destination to use a service mesh. As another example, manager 122 could access rules, policies, and other routing information that indicate whether and how to modify various connection requests. Manager 122 determines, based on the routing information, whether the first connection request to the first destination should use the service mesh.

At step 406, manager 122 obtains a first file descriptor associated with the first socket connection from the client application. In some embodiments, manager 122 obtains the first file descriptor by sending a pidfd_getfd( ) call, which returns the first file descriptor. Referring to the above example, manager 122 sends pidfd_getfd(clientfd, 5), where clientfd is the file descriptor for the client 118 process, and 5 is the file descriptor identifier used by client 118 for the first socket connection. Manager 122 receives the file descriptor for the first socket connection. In some embodiments, the file descriptor identifier used by manager 122 for the file descriptor is different from the file descriptor identifier used by client 118. For example, pidfd_getfd( ) could return the file descriptor with a file descriptor identifier of 33, which manager 122 uses to identify the file descriptor when issuing system calls.

At step 408, manager 122 generates a second connection request for the service mesh using the first socket connection. In some embodiments, manager 122 generates the second connection request using the first socket connection based on the first file descriptor obtained from the client application. For example, manager 122 could call connect(33, localhost:5678), where 33 is the file descriptor for the first socket connection and localhost:5678 is the local address of the service mesh. After the connection is established, the first socket connection is connected to the destination at the address, localhost:5678 (i.e., the service mesh). When client 118 sends and receives data via the first socket connection, the data is transmitted to and received from the service mesh.

At step 410, manager 122 causes the service mesh to connect to the first destination. For example, the service mesh connects to the destination at address 1.2.3.4. When service mesh receives data from client 118, the service mesh can pass the data on to the destination at address 1.2.3.4. Similarly, when the service mesh receives a response from the destination at address 1.2.3.4, the service mesh can pass the response to client 118.

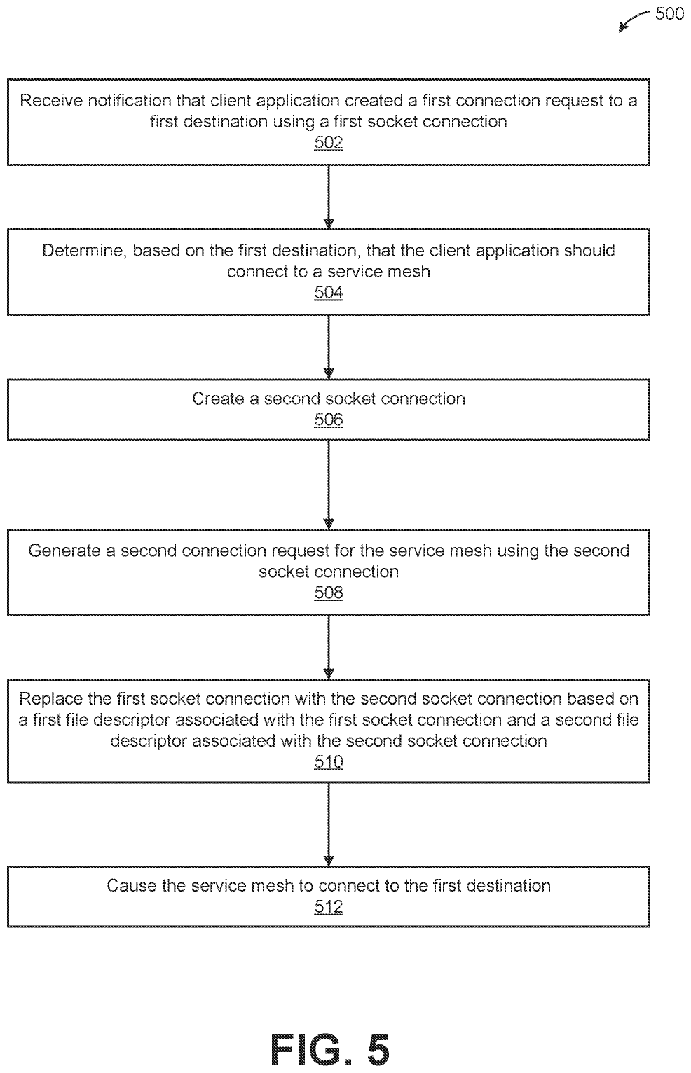

FIG. 5 sets forth a flow diagram of method steps 500 for intercepting and modifying a connection request, according to various other embodiments of the present invention. Although the method steps are described with reference to the system of FIG. 1 and call flows of FIG. 3, persons skilled in the art will understand that any system configured to implement the method steps, in any order, falls within the scope of the present invention.

As shown in FIG. 5, method 500 begins at step 502, where manager 122 receives a notification that a client application created a first connection request to a first destination using a first socket connection. For example, manager 122 receives a notification 310 from system kernel 120 that client 118 sent a system call 306. In some embodiments, notification 310 includes information identifying one or more of the client 118, the system call 306, or one or more parameters of system call 306.

At step 504, manager 122 determines, based on the first destination, that the client application should connect to a service mesh. For example, manager 122 determines that client 118 should connect to a service mesh included in intermediary services 124 for communicating with the first destination. As discussed above, in various embodiments, manager 122 determines whether client 118 should connect to a service mesh based on one or more of the identity of client 118, the first destination, and/or one or more rules, policies, or other routing information that indicate whether and how to modify different connection requests.

At step 506, manager 122 creates a second socket connection. For example, manager 122 sends a socket(AF_INET, SOCK_STREAM) call to system kernel 120, where AF_INET indicates that the communication domain for the socket is IPv4 internet protocols and SOCK_STREAM indicates that the socket is a streaming, connection-oriented socket. Manager 122 receives a file descriptor corresponding to the second socket connection from system kernel 120. Different parameter values, such as different protocol families and/or different socket types, may be used.

In some embodiments, the second socket connection uses a different socket type than the socket type used by the first socket connection. For example, client 118 could create the first socket connection using the socket( ) call described above. Manager 122 could create the second connection using the socketpair( ) call. The socketpair( ) call creates a pair of connected sockets. Manager 122 receives a pair of file descriptors corresponding to the pair of sockets from system kernel 120.

At step 508, manager 122 generates a second connection request for the service mesh using the second socket connection. In some embodiments, manager 122 generates the second connection request based on a file descriptor corresponding to the second socket connection. For example, if the second socket connection was created using a socket(AF_INET, SOCK_STREAM) call, manager 122 could call connect(34, 127.0.0.1:5678), where 34 is the file descriptor for the second socket connection. As another example, if a pair of sockets were created using socketpair( ), manager 122 could provide one of the sockets included in the pair of sockets to the service mesh. As discussed below, the other socket included in the pair of sockets is used to replace the first socket connection, i.e., the original socket from the client application. After the first socket connection is replaced, then a connection is established between the pair of sockets, i.e., between the client and the service mesh.

At step 510, manager 122 replaces the first socket connection with the second socket connection based on a first file descriptor associated with the first socket connection and a second file descriptor associated with the second socket connection. In some embodiments, manager 122 replaces the first socket connection with the second socket connection by calling addfd( ) with parameters localfd and remotefd, which replaces the file referenced by the file descriptor remotefd with the file referenced by the file descriptor localfd. For example, manager 122 could call addfd( ) with parameters 33 and 5, where 33 is the file descriptor for the second socket connection that is returned by the socket( ) call, and 5 is the file descriptor for the first socket connection. In some embodiments, to call addfd( ), manager 122 uses an input/output control system call, ioctl( ) to invoke addfd. For example, manager 122 could call ioctl(listener, ADDFD, 33, 5). In some embodiments, if a pair of socket connections were created using socketpair( ), manager 122 uses a first socket connection in the pair of socket connections to connect to a target destination, e.g., the service mesh and replaces the first socket connection with a second socket connection in the pair of socket connections. In some embodiments, connecting to a target destination using a socket connection created by socketpair( ) includes providing the socket connection to the target destination. For example, if socketpair( ) returned file descriptors 34 and 35, 34 could be used for the addfd( ) call while 35 could be provided to a service mesh. Once the service mesh has one socket connection in the pair and the client application has the other socket connection, then a connection between the client 118 and the service mesh is established.

In some embodiments, each file descriptor is in context of the component that generated the socket connection. For example, 33 is the file descriptor used by manager 122 for the second socket connection, and 5 is the file descriptor used by client 118 for the first socket connection. Therefore, in the context of manager 122, a file descriptor of 5 may be used for a file unrelated to the first socket connection or the second socket connection.

At step 512, manager 122 causes the service mesh to connect to the first destination. For example, the service mesh connects to the destination at address 1.2.3.4. When service mesh receives data from client 118, the service mesh can pass the data on to the destination at address 1.2.3.4. Similarly, when the service mesh receives a response from the destination at address 1.2.3.4, the service mesh can pass the response to client 118.

One benefit of modifying the connection type to a socket created using socketpair( ) is that the sockets created using socketpair( ) are more efficient than the socket created using socket( ). For example, connections using a socketpair( ) socket have lower CPU utilization and lower latency compared to socket( ) connections. However, socketpair( ) may only be used for local connections. When client 118 sends a connection request for an external destination, client 118 cannot use socketpair( ). When manager 122 modifies the connection request to specify an internal destination, socketpair( ) is able to be used for the internal destination. Therefore, manager 122 can modify the socket type in order to utilize the benefits of the socketpair( ) connection.

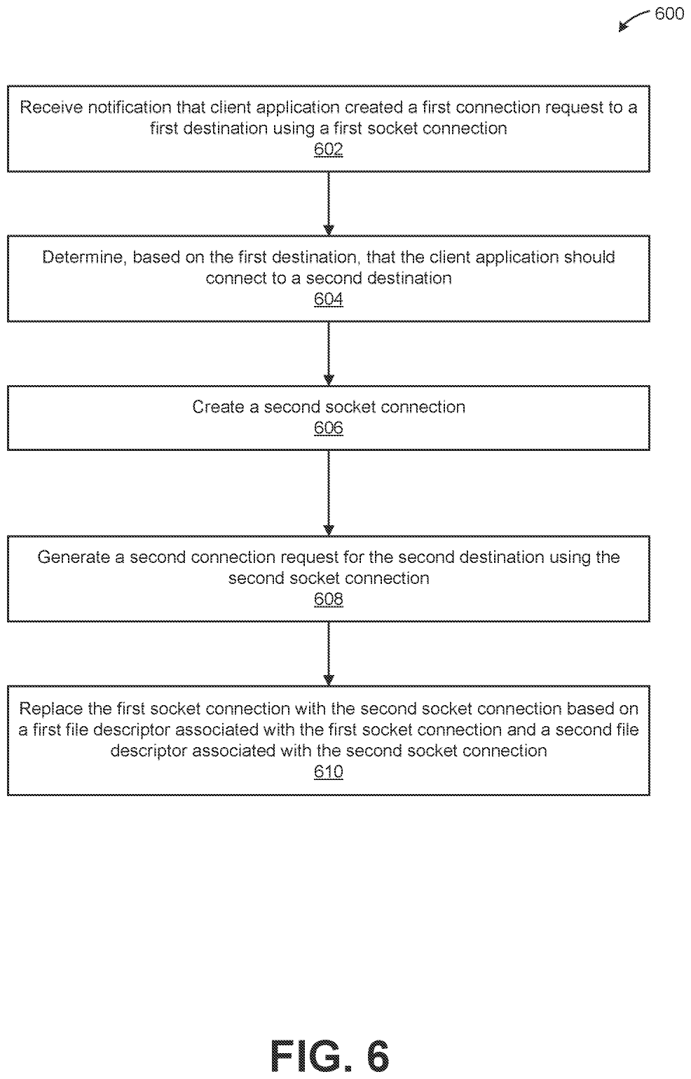

FIG. 6 sets forth a flow diagram of method steps 600 for modifying a connection request, according to various embodiments of the present invention. Although the method steps are described with reference to the system of FIG. 1 and call flows of FIG. 3, persons skilled in the art will understand that any system configured to implement the method steps, in any order, falls within the scope of the present invention.

As shown in FIG. 6, method 600 begins at step 602, where manager 122 receives a notification that a client application created a first connection request to a first destination using a first socket connection. For example, manager 122 receives a notification 310 from system kernel 120 that client 118 called a system call 306. In some embodiments, notification 310 includes information identifying one or more of the client 118, the system call 306, or one or more parameters of system call 306. As an example, client 118 calls connect(5, 1.2.3.4), where 5 is the file descriptor for the first socket connection and 1.2.3.4 is address of the first destination. Notification 310 could include indicate that the system call was a connect( ) call, that 5 is the identifier used by client 118 for the file descriptor, and/or that the target destination is the IP address 1.2.3.4.

At step 604, manager 122 determines, based on the first destination, that the client application should connect to a second destination. As discussed above, in various embodiments, manager 122 determines whether client 118 should connect to a second based on one or more of the identity of client 118, the first destination, and/or one or more rules, policies, or other routing information that indicate whether and how to modify different connection requests.

In some embodiments, the first destination is a virtual IP address, and manager 122 determines an actual IP address corresponding to the virtual IP address. Referring to the above example, the routing information could indicate, for each virtual IP address included in a plurality of virtual IP addresses, one or more actual IP addresses that correspond to the virtual IP address. Manager 122 selects, as the second destination, an actual IP address from the one or more actual IP addresses that correspond to the first destination.

At step 606, manager 122 creates a second socket connection. For example, manager 122 sends a socket(AF_INET, SOCK_STREAM) call to system kernel 120, where AF_INET indicates that the communication domain for the socket is IPv4 internet protocols and SOCK_STREAM is the socket type of the connection. Manager 122 receives a file descriptor corresponding to the second socket connection from system kernel 120. Different parameter values, such as different protocol families and/or different socket types, may be used.

In some embodiments, instead of creating a second socket connection, manager 122 obtains the file descriptor corresponding to the first socket connection. For example, manager 122 uses a pidfd_getfd( ) call to obtain the file descriptor corresponding to the first socket connection from client 118.

At step 608, manager 122 generates a second connection request for the second destination using the second socket connection. In some embodiments, manager 122 generates the second connection request based on a file descriptor corresponding to the second socket connection. For example, if the second socket connection was created using socket( ) manager 122 could call connect(34, 1.1.1.1), where 34 is the file descriptor for the second socket connection and 1.1.1.1 is the address of the second destination.

In some embodiments, if manager 122 obtained the file descriptor for the first socket connection instead of generating the second socket connection, then manager 122 generates the second connection request based on the file descriptor for the first socket connection and the second destination. For example, if manager 122 received a file descriptor identifier of 33 in response to calling pidfd_getfd( ) then manager 122 could generate the second connection request using the file descriptor identifier of 33 and the address of the second destination, e.g., using connect(33, 1.1.1.1).

At step 610, manager 122 replaces the first socket connection with the second socket connection based on a first file descriptor associated with the first socket connection and a second file descriptor associated with the second socket connection. In some embodiments, manager 122 replaces the first socket connection with the second socket connection by calling addfd( ). For example, manager 122 could call addfd( ) with parameters 33 and 5, where 33 is the file descriptor for the second socket connection that is returned by the socket( ) call, and 5 is the file descriptor for the first socket connection. In some embodiments, manager 122 uses an input/output control system call, ioctl( ) to invoke addfd. For example, manager 122 could call ioctl(listener, ADDFD, 33, 5). In some embodiments, if manager 122 created the second connection request using the file descriptor for the first socket connection, then manager 122 does not perform step 610.

At least one benefit of using the manager 122 to replace a target destination with a different destination is that the manager 122 can perform load balancing, routing, and other networking services typically provided by a service mesh without having to connect client 118 to the service mesh. Accordingly, the connection from client 118 is routed to a different destination with less process overhead and lower latency compared to routing the connection through the service mesh.

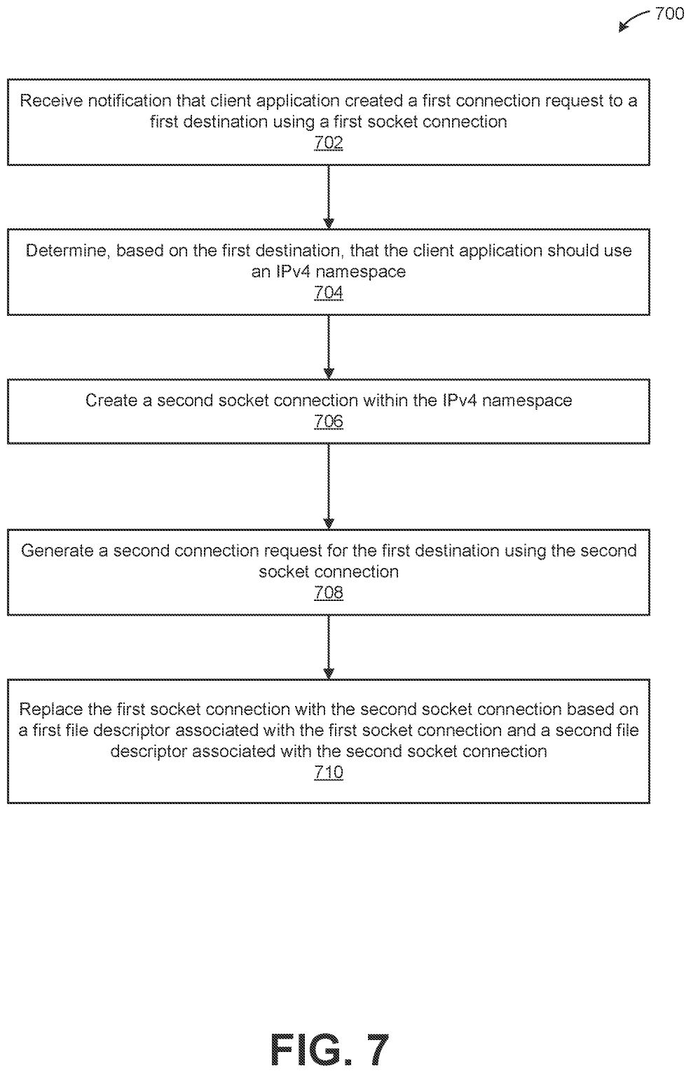

FIG. 7 sets forth a flow diagram of method steps 700 for intercepting and modifying a connection request, according to various embodiments of the present invention. Although the method steps are described with reference to the system of FIG. 1 and call flows of FIG. 3, persons skilled in the art will understand that any system configured to implement the method steps, in any order, falls within the scope of the present invention.

As shown in FIG. 7, method 700 begins at step 702, where manager 122 receives a notification that a client application created a first connection request to a first destination using a first socket connection. For example, manager 122 receives a notification 310 from system kernel 120 that client 118 called a system call 306. In some embodiments, notification 310 includes information identifying one or more of the client 118, the system call 306, or one or more parameters of system call 306. As an example, client 118 calls connect(5, 1.2.3.4), where 5 is the file descriptor for the first socket connection and 1.2.3.4 is address of the first destination. Notification 310 could include indicate that the system call was a connect( ) call, that 5 is the identifier used by client 118 for the file descriptor, and/or that the target destination is the IP address 1.2.3.4.

At step 704, manager 122 determines, based on the first destination, that the client application should use a namespace with IPv4 connectivity. For example, manager 122 determines that a communication request from client 118 should use a namespace with IPv4 connectivity. In some embodiments, determining that client 118 should use a namespace with IPv4 connectivity is based on whether the first destination is associated with an IPv4 communication domain or an IPv6 communication domain. For example, the first destination could be included in an address data structure that stores information for different fields associated with the first destination, such as a communication domain, a port number, and a network address. The value associated with the communication domain field indicates whether the first destination is associated with an IPv4 communication domain. For example, a value of “AF_INET” could be stored if the communication domain is IPv4, while a value of “AF_INET6” could be stored if the communication domain is IPv6.

In some embodiments, manager 122 also determines whether client 118 is executing in a namespace that is only assigned an IPv6 address. For example, manager 122 can determine whether client 118 is in a namespace with IPv6 connectivity based on, for example namespace information indicating attributes of different namespaces including whether each namespace is a namespace with IPv6 connectivity, a namespace with IPv4 connectivity, an IPv4 transition namespace (with IPv4 connectivity), or a combination thereof. In some embodiments, manager 122 and client 118 execute in a namespace with IPv6 connectivity, and manager 122 does not need to make such a determination.

If the first destination is associated with an IPv4 communication domain but the client 118 is in a namespace with IPv6 connectivity, then manager 122 determines that the client 118 should use a namespace with IPv4 connectivity for connecting to the first destination.

At step 706, manager 122 creates a second socket connection within a namespace with IPv4 connectivity, such as the IPv4 transition namespace. In some embodiments, manager 122 is executing in the namespace with IPv4 connectivity. When manager 122 creates the second socket connection, for example using socket(AF_INET, SOCK_STREAM), then the second socket connection is also in the namespace with IPv4 connectivity. In some embodiments, manager 122 switches namespaces to the namespace with IPv4 connectivity. In some embodiments, manager 122 switches to a namespace with IPv4 connectivity by sending a setns(fd, CLONE_NEWNET) call to system kernel 120, where fd represents a file descriptor associated with a target namespace, and CLONE_NEWNET indicates that the target namespace is a network namespace. Here, manager 122 calls setns(fd, CLONE_NEWNET) call where fd specifies the namespace with IPv4 connectivity, such as the IPv4 transition namespace.

At step 708, manager 122 generates a second connection request for the first destination using the second socket connection. In some embodiments, manager 122 generates the second connection request based on a file descriptor corresponding to the second socket connection. For example, if the second socket connection corresponds to a file descriptor with a file descriptor identifier of 34, manager 122 sends connect(34, 1.2.3.4) to system kernel 120.

At step 710, manager 122 replaces the first socket connection with the second socket connection based on a first file descriptor associated with the first socket connection and a second file descriptor associated with the second socket connection. In some embodiments, manager 122 replaces the first socket connection with the second socket connection by calling addfd( ) For example, manager 122 could addfd( ) with parameters 33 and 5, where 33 is the file descriptor for the second socket connection that is returned by the socket( ) call, and 5 is the file descriptor for the first socket connection. In some embodiments, manager 122 uses an input/output control system call, ioctl( ) to invoke addfd.

One benefit of modifying the socket connection to use a namespace with IPv4connectivity is that client 118 is able to efficiently communicate with a destination with an IPv4 address. Unlike prior techniques that modify communications on a packet-by-packet, client 118 can communicate with the IPv4 destination without an intermediary having to monitor every packet to and from client 118 to determine whether the packet destination needs to be modified. Accordingly, using the disclosed techniques, client 118 is able to transmit data using less processing power and in a faster amount of time compared to conventional techniques. Furthermore, once the connection is established, manager 122 is not involved in communications between client 118 and the destination. Even if manager 122 were to fail, established connections would not be affected by the failure. Therefore, using the disclosed techniques, client 118 is also able to transmit data more reliably compared to using a proxy service or other routing techniques.

### Network Infrastructure

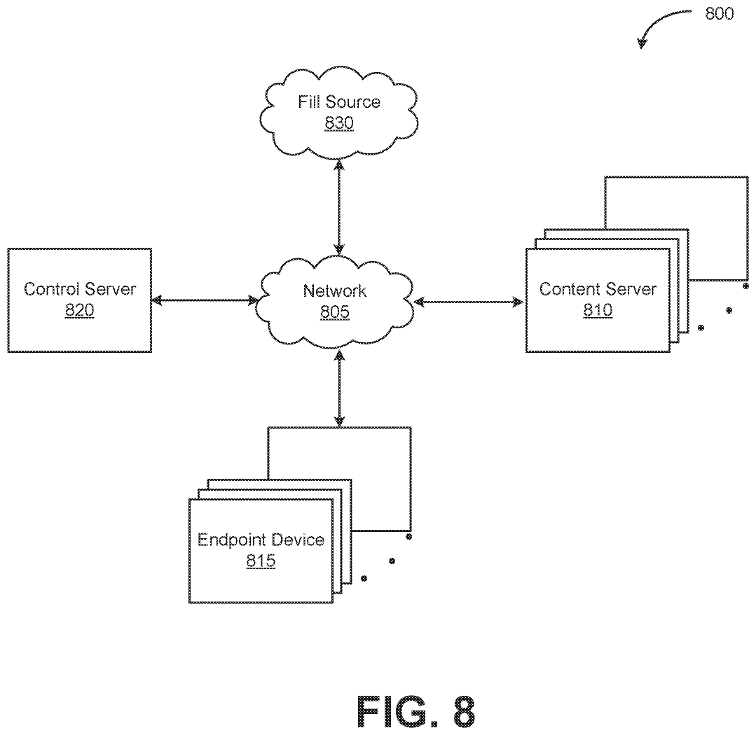

FIG. 8 illustrates a network infrastructure configured to implement one or more aspects of the various embodiments. As shown, network infrastructure 800 includes one or more content servers 810, a control server 820, and one or more endpoint devices 815, which are connected to one another and/or one or more cloud services 830 via a communications network 805. Network infrastructure 800 is generally used to distribute content to content servers 810 and endpoint devices 815.

Each endpoint device 815 communicates with one or more content servers 810 (also referred to as “caches” or “nodes”) via network 805 to download content, such as textual data, graphical data, audio data, video data, and other types of data. The downloadable content, also referred to herein as a “file,” is then presented to a user of one or more endpoint devices 815. In various embodiments, endpoint devices 815 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Network 805 includes any technically feasible wired, optical, wireless, or hybrid network that transmits data between or among content servers 810, control server 820, endpoint device 815, cloud services 830, and/or other components. For example, network 805 could include a wide area network (WAN), local area network (LAN), personal area network (PAN), WiFi network, cellular network, Ethernet network, Bluetooth network, universal serial bus (USB) network, satellite network, and/or the Internet.

Each content server 810 may include one or more applications configured to communicate with control server 820 to determine the location and availability of various files that are tracked and managed by control server 820. Each content server 810 may further communicate with cloud services 830 and one or more other content servers 810 to “fill” each content server 810 with copies of various files. In addition, content servers 810 may respond to requests for files received from endpoint devices 815. The files may then be distributed from content server 810 or via a broader content distribution network. In some embodiments, content servers 810 may require users to authenticate (e.g., using a username and password) before accessing files stored on content servers 810. Although only a single control server 820 is shown in FIG. 8, in various embodiments multiple control servers 820 may be implemented to track and manage files.

In various embodiments, cloud services 830 may include an online storage service (e.g., Amazon® Simple Storage Service, Google® Cloud Storage, etc.) in which a catalog of files, including thousands or millions of files, is stored and accessed in order to fill content servers 810. Cloud services 830 also may provide compute or other processing services. Although only a single instance of cloud services 830 is shown in FIG. 8, in various embodiments multiple cloud services 830 and/or cloud service instances may be implemented.

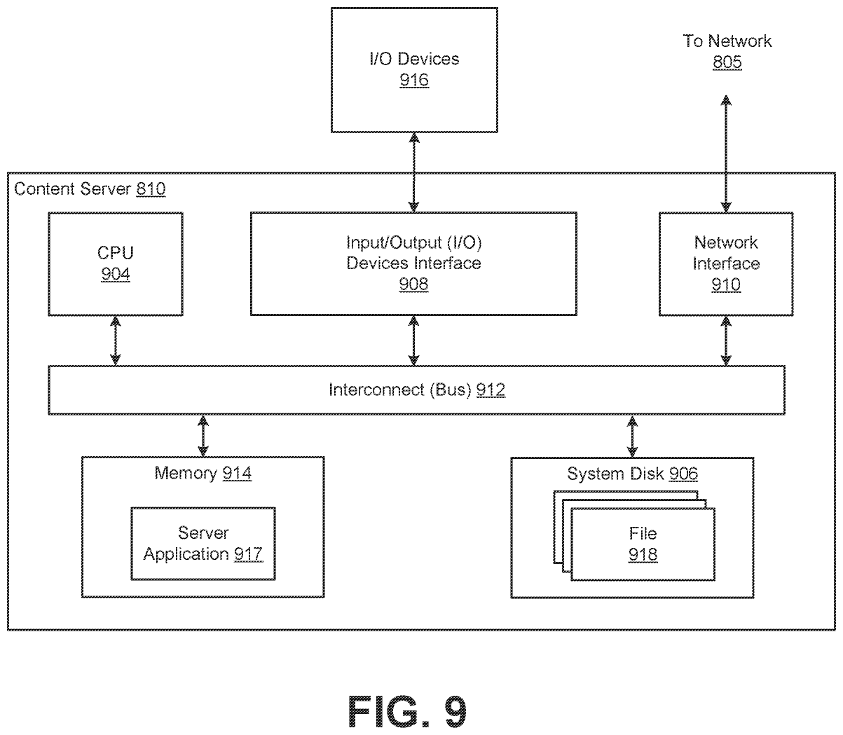

FIG. 9 is a block diagram of content server 810 that may be implemented in conjunction with the network infrastructure of FIG. 8, according to various embodiments. As shown, content server 810 includes, without limitation, a central processing unit (CPU) 904, a system disk 906, an input/output (I/O) devices interface 908, a network interface 910, an interconnect 912, and a system memory 914.

CPU 904 is configured to retrieve and execute programming instructions, such as a server application 917, stored in system memory 914. Similarly, CPU 904 is configured to store application data (e.g., software libraries) and retrieve application data from system memory 914. Interconnect 912 is configured to facilitate transmission of data, such as programming instructions and application data, between CPU 904, system disk 906, I/O devices interface 908, network interface 910, and system memory 914. I/O devices interface 908 is configured to receive input data from I/O devices 916 and transmit the input data to CPU 204 via interconnect 912. For example, I/O devices 916 may include one or more buttons, a keyboard, a mouse, and/or other input devices. I/O devices interface 908 is further configured to receive output data from CPU 904 via interconnect 912 and transmit the output data to I/O devices 916.

System disk 906 may include one or more hard disk drives, solid state storage devices, or similar storage devices. System disk 906 is configured to store non-volatile data such as files 918 (e.g., audio files, video files, subtitle files, application files, software libraries, etc.). Files 918 can then be retrieved by one or more endpoint devices 815 via network 805. In some embodiments, network interface 910 is configured to operate in compliance with the Ethernet standard.

System memory 914 includes server application 917, which is configured to service requests received from endpoint device 815 and other content servers 810 for one or more files 918. When server application 917 receives a request for a given file 918, server application 917 retrieves the requested file 918 from system disk 906 and transmits file 918 to an endpoint device 815 or a content server 810 via network 805. Files 918 include digital content items such as video files, audio files, and/or still images. In addition, files 918 may include metadata associated with such content items, user/subscriber data, etc. Files 918 that include visual content item metadata and/or user/subscriber data may be employed to facilitate the overall functionality of network infrastructure 800. In alternative embodiments, some or all of files 918 may instead be stored in a control server 820, or in any other technically feasible location within network infrastructure 800.

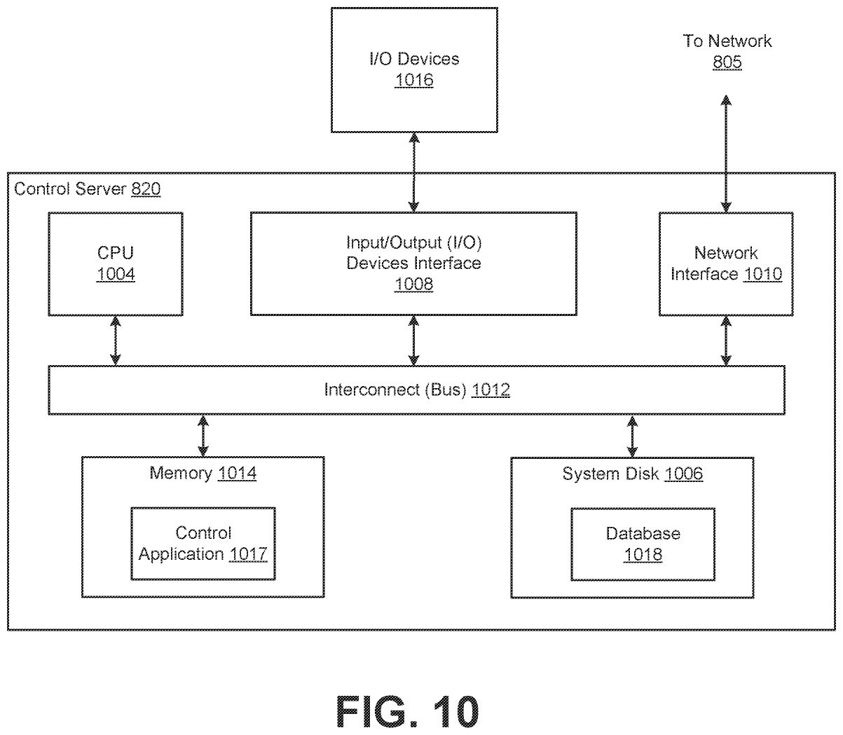

FIG. 10 is a block diagram of control server 820 that may be implemented in conjunction with the network infrastructure 800 of FIG. 8, according to various embodiments. As shown, control server 820 includes, without limitation, a central processing unit (CPU) 1004, a system disk 1006, an input/output (I/O) devices interface 1008, a network interface 1010, an interconnect 1012, and a system memory 1014.

CPU 1004 is configured to retrieve and execute programming instructions, such as control application 1017, stored in system memory 1014. Similarly, CPU 1004 is configured to store application data (e.g., software libraries) and retrieve application data from system memory 1014 and a database 1018 stored in system disk 1006. Interconnect 1012 is configured to facilitate transmission of data between CPU 1004, system disk 1006, I/O devices interface 1008, network interface 1010, and system memory 1014. I/O devices interface 1008 is configured to transmit input data and output data between I/O devices 1016 and CPU 1004 via interconnect 1012. System disk 1006 may include one or more hard disk drives, solid state storage devices, and the like. System disk 1006 is configured to store a database 1018 of information associated with content servers 810, cloud services 1100, and files 918.

System memory 1014 includes a control application 1017 configured to access information stored in database 1018 and process the information to determine the manner in which specific files 918 will be replicated across content servers 810 included in the network infrastructure 800. Control application 1017 may further be configured to receive and analyze performance characteristics associated with one or more of content servers 810 and/or endpoint devices 815. As noted above, in some embodiments, metadata associated with such visual content items, and/or user/subscriber data may be stored in database 1018 rather than in files 918 stored in content servers 810.

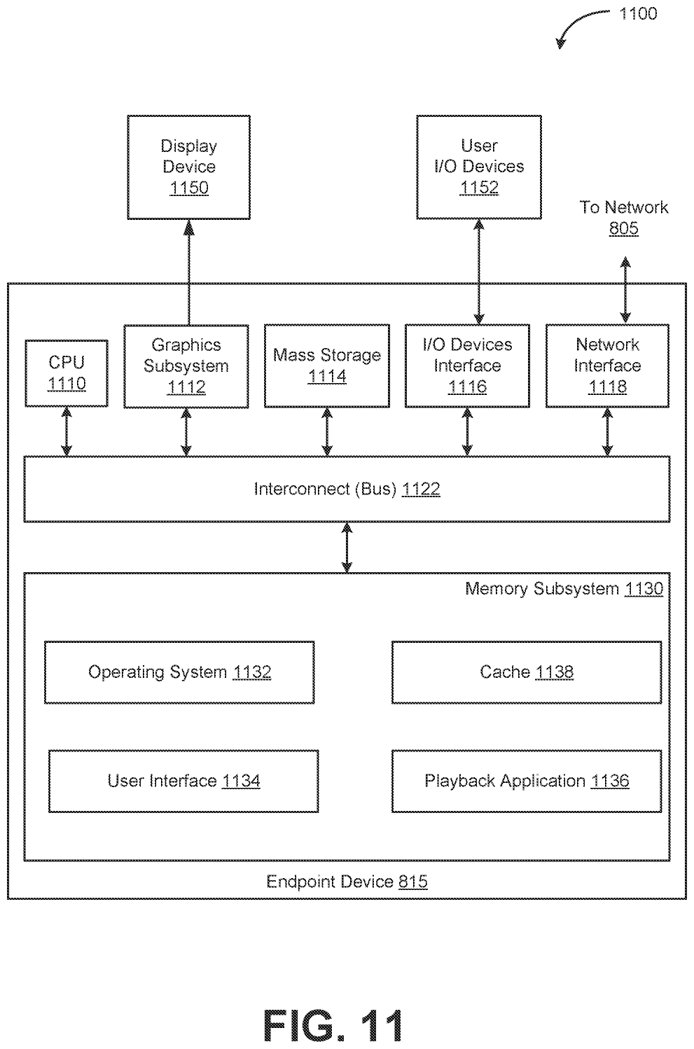

FIG. 11 is a block diagram of endpoint device 815 that may be implemented in conjunction with the network infrastructure of FIG. 8, according to various embodiments. As shown, endpoint device 815 may include, without limitation, a CPU 1110, a graphics subsystem 1112, an I/O devices interface 1114, a mass storage unit 1116, a network interface 1118, an interconnect 1122, and a memory subsystem 1130.

In some embodiments, CPU 1110 is configured to retrieve and execute programming instructions stored in memory subsystem 1130. Similarly, CPU 1110 is configured to store and retrieve application data (e.g., software libraries) residing in memory subsystem 1130. Interconnect 1122 is configured to facilitate transmission of data, such as programming instructions and application data, between CPU 1110, graphics subsystem 1112, I/O devices interface 1114, mass storage unit 1116, network interface 1118, and memory subsystem 1130.

In some embodiments, graphics subsystem 1112 is configured to generate frames of video data and transmit the frames of video data to display device 1150. In some embodiments, graphics subsystem 1112 may be integrated into an integrated circuit, along with CPU 1110. Display device 1150 may comprise any technically feasible means for generating an image for display. For example, display device 1150 may be fabricated using liquid crystal display (LCD) technology, cathode-ray technology, and light-emitting diode (LED) display technology. I/O devices interface 1114 is configured to receive input data from user I/O devices 1152 and transmit the input data to CPU 1110 via interconnect 1122. For example, user I/O devices 1152 may include one or more buttons, a keyboard, and/or a mouse or other pointing device. I/O devices interface 1114 also includes an audio output unit configured to generate an electrical audio output signal. User I/O devices 1152 includes a speaker configured to generate an acoustic output in response to the electrical audio output signal. In alternative embodiments, display device 1150 may include the speaker. Examples of suitable devices known in the art that can display video frames and generate an acoustic output include televisions, smartphones, smartwatches, electronic tablets, and the like.

A mass storage unit 1116, such as a hard disk drive or flash memory storage drive, is configured to store non-volatile data. Network interface 1118 is configured to transmit and receive packets of data via network 805. In some embodiments, network interface 1118 is configured to communicate using the well-known Ethernet standard. Network interface 1118 is coupled to CPU 1110 via interconnect 1122.

In some embodiments, memory subsystem 1130 includes programming instructions and application data that include an operating system 1132, a user interface 1134, a playback application 1136, and a platform player 1138. Operating system 1132 performs system management functions such as managing hardware devices including network interface 1118, mass storage unit 1116, I/O devices interface 1114, and graphics subsystem 1112. Operating system 1132 also provides process and memory management models for user interface 1134, playback application 1136, and/or platform player 1138. User interface 1134, such as a window and object metaphor, provides a mechanism for user interaction with endpoint device 815. Persons skilled in the art will recognize the various operating systems and user interfaces that are well-known in the art and suitable for incorporation into endpoint device 815.

In some embodiments, playback application 1136 is configured to request and receive content from content server 810 via network interface 1118. Further, playback application 1136 is configured to interpret the content and present the content via display device 1150 and/or user I/O devices 1152. In so doing, playback application 1136 may generate frames of video data based on the received content and then transmit those frames of video data to platform player 1138. In response, platform player 1138 causes display device 1150 to output the frames of video data for playback of the content on endpoint device 815. In one embodiment, platform player 1138 is included in operating system 1132.

In sum, a system kernel executing on a computing device monitors system calls generated by other applications executing on the computing device. The system kernel intercepts one or more system calls and sends the intercepted system calls to a manager. The manager modifies the system call and causes the modified system call to be executed instead of the intercepted system call. In some embodiments, the intercepted system call is a connection request from an application to a target destination. The manager modifies the connection request and causes a modified connection to be established based on the modified connection request.

In some embodiments, the manager modifies the target destination of an intercepted connection request. For example, the manager modifies an external destination to a different external destination or to an internal destination that routes communications to one or more external destinations. The modified connection connects to the modified destination, rather than the target destination specified in the intercepted communication request.

In some embodiments, the manager generates a new socket connection and modifies the socket connection used by the intercepted connection request. For example, the manager generates a socket connection of a different socket type or in a different network namespace. The modified connection connects to a target destination using the new socket connection, rather than the socket connection specified in the intercepted connection request. Additionally, the socket connection created by the application is replaced with the new socket connection created by the manager.

At least one technological advantage of the disclosed techniques relative to the prior art is that, with the disclosed techniques, a connection from a client application to an external destination is modified with more efficiently compared to prior art techniques. In particular, a connection system call made by a client application is modified by a manager application, and a connection from the client application to a different destination is established using the modified connection system call. Accordingly, using the disclosed techniques, packets and/or messages from the client application do not have to be monitored and re-routed to the different destination, which results in less processing overhead and lower packet transmission latency relative to conventional techniques. These technical advantages provide one or more technological advancements over prior art approaches.

1. In some embodiments, a computer-implemented method for modifying system calls from a client application comprises intercepting a first system call from a client application, wherein the first system call comprises a first request to connect to a first destination using a first set of system call parameters; determining, based on the first destination, a second set of system call parameters; generating a second system call, wherein the second system call comprises a second request to connect to a target destination using the second set of system call parameters; and causing a connection to be established from the client application to the target destination based on the second system call.

2. The method of clause 1, wherein the first destination is an external destination, and the target destination is an internal destination.

3. The method of clauses 1 or 2, wherein the internal destination comprises a service mesh, the method further comprising causing a second connection to be established from the service mesh to the first destination.

4. The method of any of clauses 1-3, wherein the first destination is a first external destination, and the target destination is a second external destination associated with the first external destination.

5. The method of any of clauses 1-4, wherein the first request specifies a first socket, and wherein generating the second system call comprises obtaining a file descriptor corresponding to the first socket; and specifying the first socket in the second request using the file descriptor.

6. The method of any of clauses 1-5, wherein the first request specifies a first socket, and wherein generating the second system call comprises generating a second socket; and specifying the second socket in the second request, wherein causing the connection to be established from the client application to the second destination comprises replacing the first socket with the second socket.

7. The method of any of clauses 1-6, wherein the first socket is associated with a first socket type, and wherein the second socket is associated with a second socket type.

8. The method of any of clauses 1-7, wherein the first socket is associated with a first network namespace, and wherein the second socket is associated with a second network namespace.

9. The method of any of clauses 1-8, wherein the first network namespace comprises an IPv6 namespace, and wherein second network namespace comprises an IPv4 namespace.

10. The method of any of clauses 1-9, wherein determining the second set of system call parameters is further based on one or more of: routing information associated with the first destination, reachability information associated with the first destination, policy information associated with a service mesh, or one or more rules associated with the first destination.

11. The method of any of clauses 1-10, wherein the target destination is the first destination.

12. In some embodiments, one or more non-transitory computer-readable media store instructions that, when executed by one or more processors, cause the one or more processors to perform the steps of intercepting a first system call from a client application, wherein the first system call comprises a first request to connect to a first destination using a first set of system call parameters; determining, based on the first destination, a second set of system call parameters; generating a second system call, wherein the second system call comprises a second request to connect to a target destination using the second set of system call parameters; and causing a connection to be established from the client application to the second destination based on the second system call.

13. The one or more non-transitory computer-readable media of clause 12, wherein the first destination is an external destination, and the target destination is a service mesh connected to the external destination.

14. The one or more non-transitory computer-readable media of clause 12 or 13, wherein the first system call specifies a first socket that is associated with one or more external communication protocols, and wherein generating the second system call comprises generating a second socket that is associated with one or more internal communication protocols.

15. The one or more non-transitory computer-readable media of any of clauses 12-14, wherein the first destination comprises a first virtual address, and the target destination comprises a first real address associated with the first virtual address.

16. The one or more non-transitory computer-readable media of any of clauses 12-15, wherein the first request specifies a first socket, and wherein generating the second system call comprises obtaining a file descriptor corresponding to the first socket; and specifying the first socket in the second request using the file descriptor.

17. The one or more non-transitory computer-readable media of any of clauses 12-16, wherein the first request specifies a first socket, and wherein generating the second system call comprises generating a second socket; and specifying the second socket in the second request, wherein causing the connection to be established from the client application to the second destination comprises replacing the first socket with the second socket.

18. The one or more non-transitory computer-readable media of any of clauses 12-17, wherein the first socket is associated with a first network namespace, and wherein the second socket is associated with a second network namespace.

19. The one or more non-transitory computer-readable media of any of clauses 12-18, wherein generating the second socket comprises switching from the first network namespace to the second network namespace; and generating the second socket in the second network namespace.

20. In some embodiments, a system comprises one or more memories storing instructions and one or more processors that are coupled to the one or more memories and, when executing the instructions, are configured to intercept a first system call from a client application, wherein the first system call comprises a first request to connect to a first destination using a first set of system call parameters; determine, based on the first destination, a second set of system call parameters; generate a second system call, wherein the second system call comprises a second request to connect to a target destination using the second set of system call parameters; and cause a connection to be established from the client application to the target destination based on the second system call.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for modifying system calls from a client application, the method comprising:
intercepting a first system call from a client application, wherein the first system call comprises a first request to connect to a first destination using a first set of system call parameters;
determining, based on the first destination, a second set of system call parameters;
generating a second system call, wherein the second system call comprises a second request to connect to a target destination using the second set of system call parameters; and
causing a connection to be established from the client application to the target destination based on the second system call.

2. The method of claim 1, wherein the first destination is an external destination, and the target destination is an internal destination.

3. The method of claim 2, wherein the internal destination comprises a service mesh, the method further comprising causing a second connection to be established from the service mesh to the first destination.

4. The method of claim 1, wherein the first destination is a first external destination, and the target destination is a second external destination associated with the first external destination.

5. The method of claim 1, wherein the first request specifies a first socket, and wherein generating the second system call comprises:
obtaining a file descriptor corresponding to the first socket; and
specifying the first socket in the second request using the file descriptor.

6. The method of claim 1, wherein the first request specifies a first socket, and wherein generating the second system call comprises:
generating a second socket; and
specifying the second socket in the second request, wherein causing the connection to be established from the client application to the second destination comprises replacing the first socket with the second socket.

7. The method of claim 6, wherein the first socket is associated with a first socket type, and wherein the second socket is associated with a second socket type.

8. The method of claim 6, wherein the first socket is associated with a first network namespace, and wherein the second socket is associated with a second network namespace.

9. The method of claim 8, wherein the first network namespace comprises an IPv6namespace, and wherein second network namespace comprises an IPv4 namespace.

10. The method of claim 1, wherein determining the second set of system call parameters is further based on one or more of: routing information associated with the first destination, reachability information associated with the first destination, policy information associated with a service mesh, or one or more rules associated with the first destination.

11. The method of claim 1, wherein the target destination is the first destination.

12. One or more non-transitory computer-readable media storing instructions that, when executed by one or more processors, cause the one or more processors to perform the steps of:
intercepting a first system call from a client application, wherein the first system call comprises a first request to connect to a first destination using a first set of system call parameters;
determining, based on the first destination, a second set of system call parameters;
generating a second system call, wherein the second system call comprises a second request to connect to a target destination using the second set of system call parameters; and
causing a connection to be established from the client application to the second destination based on the second system call.

13. The one or more non-transitory computer-readable media of claim 12, wherein the first destination is an external destination, and the target destination is a service mesh connected to the external destination.

14. The one or more non-transitory computer-readable media of claim 13, wherein the first system call specifies a first socket that is associated with one or more external communication protocols, and wherein generating the second system call comprises generating a second socket that is associated with one or more internal communication protocols.

15. The one or more non-transitory computer-readable media of claim 12, wherein the first destination comprises a first virtual address, and the target destination comprises a first real address associated with the first virtual address.

16. The one or more non-transitory computer-readable media of claim 12, wherein the first request specifies a first socket, and wherein generating the second system call comprises:
obtaining a file descriptor corresponding to the first socket; and
specifying the first socket in the second request using the file descriptor.

17. The one or more non-transitory computer-readable media of claim 12, wherein the first request specifies a first socket, and wherein generating the second system call comprises:
generating a second socket; and
specifying the second socket in the second request, wherein causing the connection to be established from the client application to the second destination comprises replacing the first socket with the second socket.

18. The one or more non-transitory computer-readable media of claim 17, wherein the first socket is associated with a first network namespace, and wherein the second socket is associated with a second network namespace.

19. The one or more non-transitory computer-readable media of claim 18, wherein generating the second socket comprises:
switching from the first network namespace to the second network namespace; and
generating the second socket in the second network namespace.

20. A system comprising:
one or more memories storing instructions; and
one or more processors that are coupled to the one or more memories and, when executing the instructions, are configured to:
intercept a first system call from a client application, wherein the first system call comprises a first request to connect to a first destination using a first set of system call parameters;
determine, based on the first destination, a second set of system call parameters;
generate a second system call, wherein the second system call comprises a second request to connect to a target destination using the second set of system call parameters; and
cause a connection to be established from the client application to the target destination based on the second system call.
